(19) United States
(12) Patent Application Publication
(10) Pub. No.: US 2026/0222983 A1
(43) Pub. Date: Jul. 30, 2026

(54) DEVICES, METHODS AND APPARATUSES FOR MULTICAST BROADCAST SERVICE

(71) Applicant: Nokia Technologies Oy, Espoo (FI)

(72) Inventors: Philippe GODIN, Massy (FR); Ugur Baran ELMALI, Munich (DE); Horst Thomas BELLING, Munich (DE); Bighnaraj PANIGRAHI, Bangalore (IN); Esa Mikael MALKAMÄKI, Espoo (FI); Jarkko Tuomo KOSKELA, Oulu (FI)

(21) Appl. No.: 19/144,698

(22) PCT Filed: Feb. 8, 2024
(86) PCT No.: PCT/IB2024/051175

§ 371 Date: Jun. 30, 2025

(30) Foreign Application Priority Data
Feb. 10, 2023 (IN) 202341008729

(51) Int. Cl. H04W 48/20; H04W 4/06

(52) U.S. Cl. CPC H04W 48/20; H04W 4/06

(57) ABSTRACT

Embodiments of the present disclosure disclose devices, methods and apparatuses for multicast broadcast service (MBS). 2024/166036 A terminal device receives, from a serving cell, an MBS configuration of one or more neighbour cells or neighbour frequencies for the terminal device in an inactive state. The terminal device identifies, using the received MBS configuration, at least one type of MBS transmission for one or more MBS services applicable in the one or more neighbour cells or neighbour frequencies. The terminal device performs a mobility related operation based on the at least one type of MBS transmission.

WO

### FIELD

Embodiments of the present disclosure generally relate to the field of communication, and in particular, to devices, methods, apparatuses and computer readable storage medium for multicast broadcast service (MBS).

### BACKGROUND

In the 3rd generation partnership project (3GPP) release 17, a terminal device, such as user equipment (UE), can only receive multicast/broadcast sessions in a radio resource control (RRC) connected state (may be referred to as, for example, RRC_CONNECTED state or mode). In 3GPP release 18, it is also proposed to enable reception of multicast MBS sessions in an RRC inactive state (may be referred to as, for example, RRC_INACTIVE state or mode).

For the terminal device in the RRC inactive state, it might need a cell reselection to another cell while maintaining the MBS transmission. Therefore, multicast mobility for UE in the RRC inactive state need to be further investigated and improved to enhance the MBS transmission.

### SUMMARY

In general, example embodiments of the present disclosure provide devices, methods, apparatuses and computer readable storage medium for multicast mobility.

In a first aspect, there is provided a terminal device. The terminal device may comprise one or more transceivers; and one or more processors coupled to the one or more transceivers, wherein the one or more transceivers are configured with the one or more processor to cause the terminal device to: receive, from a serving cell, a multicast/broadcast service, MBS, configuration of one or more neighbour cells or neighbour frequencies for the terminal device in an inactive state; identify, using the received MBS configuration, at least one type of MBS transmission for one or more MBS services applicable in the one or more neighbour cells or neighbour frequencies; and perform a mobility related operation based on the at least one type of MBS transmission.

In a second aspect, there is provided a network device. The network device may comprise one or more transceivers; and one or more processors coupled to the one or more transceivers, and the one or more transceivers are configured with the one or more processor to cause the network device, which provides a serving cell, to transmit, to a terminal device, a multicast/broadcast service, MBS, configuration of one or more neighbour cells or neighbour frequencies for the terminal device in an inactive state, wherein the MBS configuration is indicative of information on one of: at least one type of MBS transmission for one or more MBS services applicable in the one or more neighbour cells; or frequencies; or a cell type of the one or more neighbour cells in terms of supporting or not supporting MBS.

In a third aspect, there is provided a method at a terminal device. The method may comprise: receiving, from a serving cell, a multicast/broadcast service, MBS, configuration of one or more neighbour cells or neighbour frequencies for the terminal device in an inactive state; identifying, using the received MBS configuration, at least one type of MBS transmission for one or more MBS services applicable in the one or more neighbour cells or neighbour frequencies; and performing a mobility related operation based on the at least one type of MBS transmission.

In a fourth aspect, there is provided a method at a network device. The method may comprise: transmitting, to a terminal device, a multicast/broadcast service, MBS, configuration of one or more neighbour cells or neighbour frequencies for the terminal device in an inactive state, wherein the MBS configuration is indicative of information on one of: at least one type of MBS transmission for one or more MBS services applicable in the one or more neighbour cells or neighbour frequencies; or a cell type of the one or more neighbour cells in terms of supporting or not supporting MBS.

In a fifth aspect, there is provided an apparatus of a terminal device. The apparatus may comprise: means for receiving, from a serving cell, a multicast/broadcast service, MBS, configuration of one or more neighbour cells or neighbour frequencies for the terminal device in an inactive state; means for identifying, using the received MBS configuration, at least one type of MBS transmission for one or more MBS services applicable in the one or more neighbour cells or neighbour frequencies; and means for performing a mobility related operation based on the at least one type of MBS transmission.

In a sixth aspect, there is provided an apparatus of a network device. The apparatus may comprise: means for transmitting, to a terminal device, a multicast/broadcast service, MBS, configuration of one or more neighbour cells or neighbour frequencies for the terminal device in an inactive state, wherein the MBS configuration is indicative of information on one of: at least one type of MBS transmission for one or more MBS services applicable in the one or more neighbour cells or neighbour frequencies; or a cell type of the one or more neighbour cells in terms of supporting or not supporting MBS.

In a seventh aspect, there is provided a terminal device. The terminal device may comprise at least one processor; and at least one memory including computer program codes, wherein the at least one memory and the computer program codes are configured to, with the at least one processor, cause the terminal device to: receive, from a serving cell, a multicast/broadcast service, MBS, configuration of one or more neighbour cells or neighbour frequencies for the terminal device in an inactive state; identify, using the received MBS configuration, at least one type of MBS transmission for one or more MBS services applicable in the one or more neighbour cells or neighbour frequencies; and perform mobility related operation based on the at least one type of MBS transmission.

In an eighth aspect, there is provided a network device. The network device may comprise at least one processor; and at least one memory including computer program codes, wherein the at least one memory and the computer program codes are configured to, with the at least one processor, cause the network device providing a serving cell to transmit, to a terminal device, a multicast/broadcast service, MBS, configuration of one or more neighbour cells or neighbour frequencies for the terminal device in an inactive state, wherein the MBS configuration is indicative of information one of: on at least one type of MBS transmission for one or more MBS services applicable in the one or more neighbour cells or neighbour frequencies; or a cell type of the one or more neighbour cells in terms of supporting or not supporting MBS.

In a ninth aspect, there is provided a non-transitory computer readable medium comprising program instructions for causing an apparatus to perform at least the method according to third or fourth aspect.

In a tenth aspect, there is provided a computer program comprising instructions, which, when executed by an apparatus, cause the apparatus at least to: receive, from a serving cell, a multicast/broadcast service, MBS, configuration of one or more neighbour cells or neighbour frequencies for the terminal device in an inactive state; identify, using the received MBS configuration, at least one type of MBS transmission for one or more MBS services applicable in the one or more neighbour cells or neighbour frequencies; and perform a mobility related operation based on the at least one type of MBS transmission.

In an eleventh aspect, there is provided a computer program comprising instructions, which, when executed by an apparatus, cause the apparatus at least to transmit, to a terminal device, a multicast/broadcast service, MBS, configuration of one or more neighbour cells or neighbour frequencies for the terminal device in an inactive state, wherein the MBS configuration is indicative of information on one of: at least one type of MBS transmission for one or more MBS services applicable in the one or more neighbour cells or neighbour frequencies; or a cell type of the one or more neighbour cells in terms of supporting or not supporting MBS.

In a twelfth aspect, there is provided a terminal device. The terminal device may comprise a receiving circuitry configured to: receive, from a serving cell, a multicast/broadcast service, MBS, configuration of one or more neighbour cells or neighbour frequencies for the terminal device in an inactive state; identify, using the received MBS configuration, at least one type of MBS transmission for one or more MBS services applicable in the one or more neighbour cells or neighbour frequencies; and perform a mobility related operation based on the at least one type of MBS transmission.

In a thirteenth aspect, there is provided a network device. The network device may comprise transmitting circuitry configured to transmit, to a terminal device, a multicast/broadcast service, MBS, configuration of one or more neighbour cells or neighbour frequencies for the terminal device in an inactive stat, wherein the MBS configuration is indicative of information on one of: at least one type of MBS transmission for one or more MBS services applicable in the one or more neighbour cells or neighbour frequencies; or a cell type of the one or more neighbour cells in terms of supporting or not supporting MBS.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example network environment in which example embodiments of the present disclosure may be implemented;

FIG. 2 illustrates an example flowchart of a method implemented at a terminal device according to example embodiments of the present disclosure;

FIG. 3 illustrates an example flowchart of a method implemented at a network device according to example embodiments of the present disclosure;

FIG. 4 illustrates an example signaling process for reporting measurements on reference signals according to some embodiments of the present disclosure;

FIG. 5 illustrates an example simplified block diagram of a device that is suitable for implementing embodiments of the present disclosure; and

FIG. 6 illustrates an example block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as long term evolution (LTE), LTE-advanced (LTE-A), wideband code division multiple access (WCDMA), high-speed packet access (HSPA), narrow band internet of things (NB-IoT) and so on. Furthermore, the communications between a terminal device and a network device in the communication network may be performed according to any suitable generation communication protocols, including, but not limited to, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a new radio (NR) NB (also referred to as a gNB), a remote radio unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an internet of things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

The term “transceiver” may refer to any device that may be coupled to one or more antennas or antenna ports to wirelessly transmit and/or receive communication signals. The antennas or antenna ports may be the same or different types. The antennas or antenna ports may be located in different positions of an apparatus. One or more transceivers allow the apparatus to communicate with other devices that may be wired and/or wireless. The one or more transceivers may include processors, controllers, radios, sockets, plugs, buffers, or the like circuits to form one or more communication channels to one or more radio frequency units. The one or more transceivers may be integrated in an apparatus or a system, for example a cellular communication apparatus or system, a wireless local area network (WLAN) system, or a short ranging system for example Bluetooth system.

In the 3GPP release 17, UE can only receive MBS multicast sessions in the RRC connected state. Between 5G core network (5GC) and new generation radio access node (NG-RAN), there are two possible delivery methods to transmit the MBS data.
Individual MBS traffic delivery method: This method is only applied for multicast MBS sessions. The 5GC may receive a single copy of MBS data packets and deliver separate copies of those MBS data packets to individual UE via per-UE PDU sessions, hence for each such UE one PDU session is required to be associated with a Multicast MBS session.
Shared MBS traffic delivery method: This method is applied for both broadcast and multicast MBS sessions. The 5GC may receive a single copy of MBS data packets and deliver a single copy of those MBS packets to an NG-RAN node, which then delivers the packets to one or multiple UE.
   The individual delivery mode is less efficient but has an advantage to enable multicast data delivery even when the UE is located in a legacy gNB i.e. a gNB which does not support the MBS at all.

Currently, 3GPP RAN has started a new work item in the release 18 to also enable reception of multicast MBS sessions in the RRC inactive state along the following scope of work:
Specify support of multicast reception by UE in RRC_INACTIVE state [RAN2, RAN3];
Study the impact of mobility and state transition for UE receiving multicast in RRC_INACTIVE. (Seamless/lossless mobility is not required) [RAN2, RAN3].

For the terminal device in the RRC inactive state, it might need a cell reselection to another cell while maintaining the MBS transmission. Therefore, multicast mobility for UE in the RRC inactive state need to be further investigated and improved to enhance the MBS transmission.

For broadcast sessions in the release 17, it has the following solution for the cell reselection:

For UE receiving a broadcast session (for example, a temporary mobile group identity, TMGI)1 in RRC inactive state:
the network broadcast in a serving cell in system information block (SIB) the mapping between FSAI(s) (frequency selection area identities associated with TMGIs and built in relation to their broadcast areas) and neighbour frequencies (i.e. frequencies used by neighbour cells);
the UE has received in service announcement from core network (CN) the mapping between FSAI(s) and the TMGI(s) of broadcast services.

Using these two mappings, the UE can determine which frequency it should preferably select when making cell reselection in order to keep the ongoing broadcast service TMGI 1.

The following example illustrates how this works for broadcast release 17:
Service announcement: TMGI 1 maps to FSAI1, FSAI20, FSAI40
Serving cell SIB21: (neighbour frequency 1 maps to FSAI 4, 5, 7, 9), (neighbour frequency 2 maps to FSAI 1, 2, 3)
   If UE is receiving the broadcast session TMGI 1, and if it has the choice at cell reselection between a cell of frequency 1 and one of frequency 2, it will preferably reselect the cell of frequency 2 because neighbour frequency 2 supports FSAI 1 (according to SIB21) which is one matching TMGI 1 (according to the earlier service announcement received by the UE from the CN). By choosing frequency 2 at cell reselection, the broadcast service continuity is kept.

Due to similarities, it was proposed to reuse the same solution for RRC_inactive UE in the release 18 for multicast cases as the one described above for RRC_inactive UE in the release 17 broadcast cases. However, the inventors found that such a solution may not work well for the multicast cases since some problems might be involved.

The inventors noticed that a major difference between broadcast and multicast transmissions lies in that multicast session may enable delivery of multicast data even in gNBs which do not support at all MBS service, i.e. called MBS non-supporting nodes. This is called an individual delivery mode. Therefore, in the release 18 during the mobility of UE in the RRC inactive state, which is receiving a multicast session of TMGI 1 in a serving cell offering TMGI 1 in the shared delivery mode, the UE can be heading towards different types of target cells as potential candidates for cell re-selection:
Target cell in a neighbour frequency offering the multicast session TMGI 1 in MBS shared delivery mode (called for example type 1 hereinafter);
Target cell in a neighbour frequency offering the multicast session TMGI 1 in MBS individual delivery mode (called for example type 2 hereinafter); and
Target cell in a neighbour frequency not offering TMGI 1 at all (e.g. outside of TMGI 1 multicast service area) (called for example type 3 hereinafter).

Thus, different types of the target cell where the UE will eventually move to will have different consequences.
If the UE eventually happens to move into in a target cell of type 1, then the UE will continue receiving TMGI 1 smoothly with no interruption.
If the UE eventually happens to move instead into a target cell of type 2, then the UE will experience a disruption in service continuity: the UE will first realize that TMGI 1 is not delivered in the point-to-multipoint (PTM) mode of the shared delivery in that target cell and will need to perform RRC reconnection procedure in that target cell. After that it will contact the session management function (SMF) about the TMGI 1, then the contacted SMF will trigger the switch from the shared delivery mode to the individual delivery mode. This overall leads to a long interruption, extra-processing and data loss. In addition, more radio resources are used for separate delivery to each UE via the individual delivery than for type 1 target cells, where PTM delivery is used at the radio interface, which is not desirable from the operator's perspective.
If the UE eventually happens to move instead into a target cell of type 3, then the UE will have not only an interruption but also a total loss of TMGI 1 multicast service because that target cell does not offer TMGI 1.

Therefore, mobility towards a cell of type 1 is better for the UE's multicast reception in RRC inactive than moving towards cell of type 2 which is in turn better than moving towards cell of type 3. However, currently the UE has no any means to differentiate between these types of target cells to influence its mobility decisions, neither before cell reselection nor during cell reselection.

According to embodiments of the present disclosure, there is provided a solution that helps a terminal device in an inactive state and receiving a multicast session in a serving cell to discriminate different types of potential target during its mobility. With this solution, the terminal device in the inactive state receives from a serving cell an MBS configuration of one or more neighbour cells or neighbour frequencies for the terminal device. The MBS configuration may indicate information on the type of MBS transmission for one or more MBS services applicable in the one or more neighbour cells or neighbour frequencies. The terminal device may use the received MBS configuration to perform a mobility related operation. For example, the terminal device may identify, at least one type of MBS transmission for one or more MBS services applicable in the one or more neighbour cells or neighbour frequencies, and then perform a mobility related operation based on the at least one type of MBS transmission.

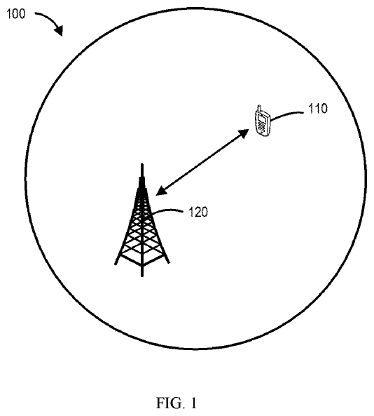

Hereinafter, principle and embodiments of the present disclosure will be described in detail below with reference to the accompanying drawings. Reference is first made to FIG. 1, which illustrates an example environment 100 in which example embodiments of the present disclosure can be implemented.

The environment 100, which may be a part of a communication network, comprises a terminal device 110 and a network device 120 communicating with each other or with other devices via each other. The communication environment 100 may comprise any suitable number of devices and cells. In the communication environment 100, the terminal device 110 and the network device 120 can communicate data and control information with each other. A link from the network device 120 to the terminal device 110 is referred to as a downlink (DL), while a link from the terminal device 110 to the network device 120 is referred to as an uplink (UL).

It is to be understood that two devices are shown in the environment 100 only for the purpose of illustration, without suggesting any limitation to the scope of the present disclosure. In some example embodiments, the environment 100 may comprise a further device to communicate with the terminal device 110 and network device 120.

The communications in the environment 100 may follow any suitable communication standards or protocols, which are already in existence or to be developed in the future, such as universal mobile telecommunications System (UMTS), long term evolution (LTE), LTE-Advanced (LTE-A), the fifth generation (5G) new radio (NR), wireless fidelity (Wi-Fi) and worldwide interoperability for microwave access (WiMAX) standards, and employs any suitable communication technologies, including, for example, multiple-input multiple-output (MIMO), orthogonal frequency division multiplexing (OFDM), time division multiplexing (TDM), frequency division multiplexing (FDM), code division multiplexing (CDM), bluetooth, zigbee, and machine type communication (MTC), enhanced mobile broadband (eMBB), massive machine type communication (mMTC), ultra-reliable low latency communication (URLLC), carrier aggregation (CA), dual connectivity (DC), and new radio unlicensed (NR-U) technologies.

The network device 120 transmits to the terminal device 110, a multicast/broadcast service (MBS) configuration of one or more neighbour cells or neighbour frequencies for the terminal device in an inactive state. The terminal device 10 receives the MBS configuration and identifies, using the received MBS configuration, at least one type of MBS transmission for one or more MBS services applicable in the one or more neighbour cells or neighbour frequencies. The terminal device 110 may perform a mobility related operation based on the at least one type of MBS transmission.

By identifying different types of potential target cells for its mobility, the terminal device 110 in the inactive state perform mobility related operations based on the identified types to improve the MBS multicast services. For example, during movement to a target cell identified as not supporting MBS, the terminal device 110 may reestablish a RRC connected state in the serving cell, such that it can reduce the interrupt and data loss caused by the switch from the shared delivery mode to the individual delivery mode. In addition, the terminal device 110 may also take into account the frequencies of the identified types of cells for the availability of MBS service when it is making a cell reselect decision, so as to ensure continuity of its MBS service.

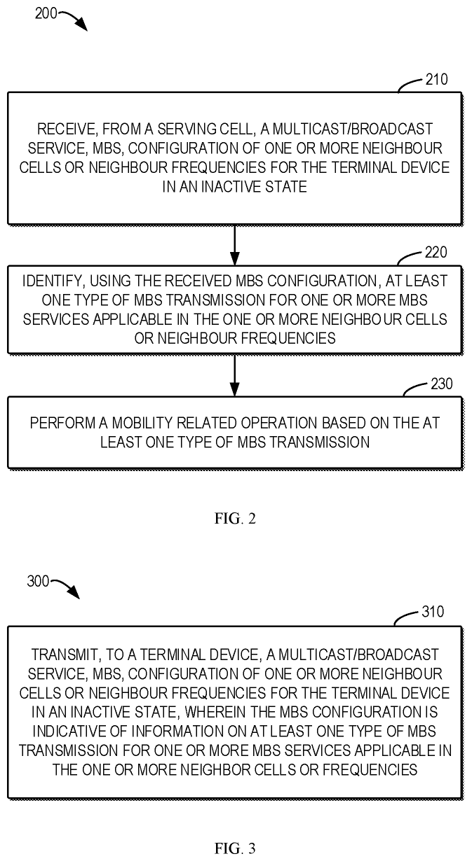

FIG. 2 illustrates an example flowchart of a method 200 implemented at a terminal device according to example embodiments of the present disclosure. For the purpose of discussion, the method 200 will be described from the perspective of the terminal device 110 with reference to FIG. 1.

As shown in FIG. 2, at 210, the terminal device 110 receives from a serving cell, a multicast/broadcast service, MBS, configuration of one or more neighbour cells or neighbour frequencies for the terminal device in an inactive state. The terminal device 110 may receive the MBS configuration from a network device 120 which is providing the serving cell.

The received MBS configuration is indicative of information on at least one type of MBS transmission for one or more MBS services applicable in the one or more neighbour cells or neighbour frequencies or a cell type of the one or more neighbour cells in terms of supporting or not supporting MBS. The type of MBS transmission may be, for example, TMGI specific, Cell specific, or gNB specific.

The term “TMGI” used herein may refer to an identity for identifying the multi-cast session. A TMGI may correspond a session of MBS, for example an audio MBS session or a video MBS session. Thus, the “TMGI specific” means the type of MBS transmission is MBS session specific, i.e., different session may have different types of MBS transmission. In some embodiments, the type of MBS transmission may also be service type specific.

In some embodiments, the MBS configuration may comprise a list of the one or more neighbour cells or frequencies and indication information corresponding to the one or more neighbour cells or frequencies. The indication information may be indicative of the type(s) of the MBS transmission respectively supported in the one or more neighbour cells for the one or more MBS services. Alternatively or additionally, the indication information may be indicative of a cell type of the one or more neighbour cells in terms of supporting MBS or not supporting MBS.

In some embodiments, the network device 120 providing the serving cell may transmits a set of lists including one or more information lists as the MBS configuration, for example, by a broadcast message. The terminal device 110 may receive the set of lists and deduce the type(s) of the one or more neighbour cells or frequencies based on the lists or deduce the transmission mode for one or more MBS services applicable to one or more neighbour cells or frequencies, which will be described later. The set of lists transmitted from the serving cell may comprise any of the following:
list 1: a list of (neighbour cell, supported TMGI(s)),
list 2: a list of neighbour cells which support or do not support the MBS,
list 3: a list of (neighbour frequency, TMGI(s) supported in this frequency).
   For list 1, alternatively or additionally, the set of lists may include
list 1b: a list of (neighbour frequency, supported TMGI(s)),
   For list 2, alternatively or additionally, the set of lists may include
list 2b: a list of neighbour frequencies which support or do not support the MBS,
   For list 3, alternatively or additionally, the set of lists may include
list 3b: a list of (neighbour FSAI, neighbour cells supporting this FSAI),
list 3c: a list of (neighbour frequency, neighbour cells on this frequency),

Therefore, the list 1 comprises the one or more neighbour cells and the one or more temporary mobile group identities, TMGIs, respectively supported in the one or more neighbour cells. The list 1b comprises the one or more neighbour frequencies and the one or more TMGIs respectively supported in the one or more neighbour frequencies.

The list 2 comprises neighbour cells which support or do not support MBS. The list 2b comprises neighbour frequencies which support or do not support MBS. Supporting MBS means the multicast service data can be transmitted in the MBS shared delivery mode for a cell within the multicast service area, while not supporting the MBS means the multicast service data can only be transmitted in the individual delivery mode for a cell within the multicast service area. Thus, the list 2 may also be a list of neighbour cells offering the MBS service(s) in the MBS shared delivery mode or in the MBS individual delivery mode, and the list 2b may be a list of neighbour frequencies offering the MBS service(s) in the MBS shared delivery mode or in the MBS individual delivery mode.

The list 3 comprises the one or more neighbour frequencies and the one or more FSAIs, respectively supported on the one or more neighbour frequencies. The list 3b comprises the one or more neighbour FSAIs and at least one neighbour cell respectively supporting one or more neighbour FSAIs. The list 3c comprises the one or more neighbour frequencies and at least one neighbour cell respectively supported on one or more neighbour frequencies.

It is to be noted that the terminal device 110 may receive some of the above mentioned lists in the MBS configuration and deduce one or more of other lists based on the received lists and/or lists transmitted in other messages or also based on own measurements.

At 220, the terminal device 110 identifies, using the received MBS configuration, at least one type of MBS transmission for one or more MBS services applicable in the one or more neighbour cells or neighbour frequencies.

As described above, the terminal device 110 may receive one or more MBS services (e.g. including a multicast service) from the serving cell in an MBS shared delivery mode. The MBS service may represented by a TMGI (e.g. TMGI 1) of an MBS session. The received MBS configuration may be indicative of information on at least one type of MBS transmission for one or more MBS services applicable in the one or more neighbour cells or neighbour frequencies; or a cell type of the one or more neighbour cells in terms of supporting or not supporting MBS. In such a case, based on the received MBS configuration, the terminal device may identify at least one type of MBS transmission for one or more MBS services applicable in the one or more neighbour cells or neighbour frequencies.

For example, the identified at least one type of MBS transmission may be an MBS shared delivery (hereafter “type 1”), which means the corresponding neighbour cell is capable of providing the ongoing MBS service in shared delivery as in the serving cell. If the terminal device 110 moves into the neighbour cell of the MBS shared delivery mode, it will continue receiving the MBS service smoothly with minimized interruption.

In some embodiments, the identified at least one type of MBS transmission may be an MBS individual delivery mode (hereafter “type 2”), which means the corresponding neighbour cell can only provide the ongoing MBS service in individual delivery, but not in shared delivery as did in the serving cell. For example, the network device 120 is a legacy gNB which does not support MBS at all. If the terminal device 110 moves into the neighbour cell only supporting the MBS individual delivery mode, it can still continue the MBS service in the cell, but extra overhead or much larger interruption will be caused to switch from a shared delivery to an individual delivery.

In some embodiments, the identified at least one type of MBS transmission may also be an MBS non-delivery mode (hereafter “type 3”), which means the ongoing MBS service in the serving cell is not provided at all. The terminal device 110 will lose the MBS service completely if it moves into a neighbour cell with the MBS non-delivery mode.

In addition, in case when the type of MBS transmission is TMGI specific, Cell specific, or gNB specific, the identified at least one type of MBS transmission may include more than one type corresponding to more than one TMGI.

At block 230, the terminal device 110 may perform a mobility related operation based on the at least one type of MBS transmission. By identifying type(s) of MBS transmission in the one or more neighbour cells or neighbour frequencies, the terminal device 110 in the inactive state and receiving an ongoing MBS service can discriminate different types of potential target cells or frequencies for its mobility, and perform mobility related operations based on the identified types to improve its MBS services.

In some embodiments, the terminal device 110 may determine, based on the identified at least one type of MBS transmission, that the terminal device 110 is heading towards a target cell providing a MBS service in an individual delivery mode. In other words, the terminal device 110 is heading towards a target cell providing an MBS service in an individual delivery mode, i.e. a cell of type 2. If the terminal device 110 checks and finds that it is heading to a target cell of type 2, it may perform an RRC reconnection/reconfiguration in the serving cell. The trigger for the checking may be based on a certain radio criteria, such as based on a reference signal receiving power (RSRP) level of the serving cell, a difference between the RSRP of the serving cell and the RSRP of the target cell, and etc. In some embodiments the reconnection to the serving cell takes place before a cell re-selection takes place.

In some embodiments, the terminal device 110 may perform a cell reselection based on the identified at least one type of MBS transmission. For example, the terminal device 110 may perform the cell reselection based on frequency priorities of the one or more neighbour cells. The frequency priorities of the one or more neighbour cells may be determined based on the identified at least one type of MBS transmission for the one or more MBS services applicable in the one or more neighbour cells.

In some embodiments, the terminal device 110 may obtain a prioritized list of neighbour frequencies of the one or more neighbour cells based on the identified at least one type of MBS transmission for the one or more MBS services in the one or more neighbour cells. The neighbour frequencies may be prioritized in an order of supporting an MBS shared delivery mode, supporting an MBS individual delivery mode, and not supporting a delivery of the one or more MBS services.

In other words, a target cell in a neighbour frequency offering the multicast service of TMGI 1 in the MBS shared delivery mode (the cell of type 1) is prioritized than a target cell in a neighbour frequency offering TMGI 1 in the MBS individual delivery mode (the cell of type 2). The cell of type 2 is further prioritized than a target cell in a neighbour frequency not offering TMGI 1 at all (e.g. outside of TMGI 1 multicast service area), i.e., the cell of type 3.

In some embodiments, the at least one type of MBS transmission may be determined based on the knowledge of MBS service areas. For example, the terminal device 110 may determine a target cell to be of type 3 if the target cell is out of the service area of its TMGI(s) of MBS service(s).

For illustrative purposes, some example solutions are given below to show how the terminal device 110 discriminates or identifies different types of neighbour cells or frequencies based on the MBS configuration and how the terminal device behaves accordingly.

### Example Solution 1a (a Connection Solution Based on a Broadcast List of Cells or Frequencies)

In this solution, the serving gNB1 cell 1 may broadcast the list 1 of mapping (neighbour cell, supported TMGI(s)). In addition, the serving gNB1 cell 1 may additionally broadcast the list 2 of neighbour cells which support/or do not support MBS (or at least among those cells which support the TMGI 1, i.e. the service areas of TMGI 1).

Before the cell reselection algorithm is triggered, the terminal device 110 may check if it is heading towards a target cell which supports TMGI 1 according to the list 1 and which is not MBS supporting according to list 2, that is, whether the target cell (gNB2 cell 2) is a cell of type 2. If yes, the terminal device 110 may trigger RRC reconnection in the current serving gNB1 cell 1 to reach RRC connected mode. The trigger for the checking may be based on radio criteria such as based on RSRP level of gNB1 cell 1 or such as difference between the RSRP of serving gNB1 cell 1 and the RSRP of target gNB2 cell 2.

### Example Solution 1b (a Reselection Solution Based on Broadcast List of Cells or Frequencies)

In this solution, the serving gNB1 cell 1 currently broadcasts the list 1 of mapping (neighbour cell, supported TMGI(s)). In addition, the serving gNB1 cell 1 broadcasts the list 1b of mapping (neighbour frequency, supported TMGI(s)) or the terminal device 110 may deduce the list 1b from the existing list 1 using its own mapping of (neighbour cell, neighbour frequency). The serving gNB1 cell 1 may broadcast the list 2b of neighbour frequencies which support/do not support MBS or the serving gNB1 cell 1 may broadcast the list 2 of neighbour cells which support/or do not support MBS. Also, the terminal device 110 may deduce the list 2b from the list 2 using its own (neighbour cell, neighbour frequency) mapping.

If the serving gNB1 cell 1 only broadcasts the list 1 and the list 2, the terminal device 110 may build the list 1b and the list 2b out of list 1 and list 2 as described above. The cell reselection algorithm may take into account the list 1b and the list 2b. In some embodiments, the terminal device prioritizes neighbour frequencies, for example, as below:
the target frequency which supports TMGI 1 according to the list 1b and which is MBS supporting according to list 2b, followed by
the target frequency which supports TMGI 1 according to the list 1b and which is not MBS supporting according to list 2b, followed by
Other target frequencies.

### Example Solution 2a (Connection Solution Reusing FSAI, FSAI Allocated to Both Shared and Individual Delivery)

In this solution, the terminal device 110 may have a service announcement comprising mapping between TMGI(s) and FSAI(s). The terminal device 110 may receive the MBS configuration from the serving gNB1 cell 1. In addition, the serving gNB1 cell 1 may broadcast the list 3 of mapping (neighbour frequencies, FSAI (s)). In addition, the serving gNB1 cell 1 may additionally broadcast the list 3b indicating the mapping between FSAI(s) and neighbour cells. Alternatively, the serving gNB1 cell 1 may broadcast the list 3c indicating the mapping between neighbour frequencies and neighbour cells. Besides, the serving gNB1 cell 1 may also additionally broadcast the list 2 of neighbour cells which support/or do not support MBS. Alternatively, the terminal device 110 may deduce the list 3c using its own (neighbour cell, neighbour frequency) mapping, if the gNB1 cell 1 broadcasts neither list 3b nor the list 3c.

In this solution, the terminal device 110 is configured or indicated that the FSAI(s) are allocated to both shared and individual delivery. Therefore, the FSAI(s) in the MBS configuration may comprise both FSAIs associated with the MBS shared delivery mode and FSAIs associated with the MBS individual delivery mode.

Before the cell reselection algorithm is triggered, the terminal device 110 may check whether it is heading towards a target cell which supports FSAI 1 of TMGI 1 (by use of the service announcement) according to list 3b (or alternatively according to list 3 and 3c), and which is not MBS supporting according to list 2. That is, the terminal device 110 checks whether the target cell is a cell of type 2 (i.e. supporting TMGI and not supporting MBS). If yes, the terminal device 110 may perform a RRC reconnection in the current serving gNB1 cell 1 to reach RRC connected mode. As above mentioned, the trigger for checking may be based on radio criteria such as based on RSRP level of gNB1 cell 1 or such as difference between the RSRP of serving gNB1 cell 1 and the RSRP of target gNB2 cell 2.

### Example Solution 2b (a Reselection Solution Reusing FSAI, FSAIs Allocated to Both Shared and Individual Delivery)

In this solution, the terminal device 110 may have a service announcement comprising a mapping between TMGI(s) and FSAI(s). The terminal device 110 may receive the MBS configuration from the serving gNB1 cell 1. In this solution, the serving gNB1 cell 1 may broadcast the list 3 of mapping (neighbour frequencies, FSAI (s)). The serving gNB1 cell 1 may broadcast the list 2b of neighbour frequencies which support/do not support MBS. Alternatively, the serving gNB1 cell 1 may broadcast the list 2 of neighbour cells which support/or do not support MBS and the terminal device 110 may deduce the list 2b from the list 2 using its own (neighbour cell, neighbour frequency) mapping if not broadcasted by the serving gNB1 cell 1.

In this solution, the terminal device 110 is configured with or indicated FSAI(s) allocated to both shared and individual delivery. Therefore, the FSAI(s) in the MBS configuration may comprise both FSAIs associated with the MBS shared delivery mode and FSAIs associated with the MBS individual delivery mode.

In this solution, the reselection algorithm of terminal device 110 may take into account the list 3 and the list 2b. The terminal device 110 may prioritize neighbour frequencies, for example, as below:
the target frequency which supports FSAI 1 of TMGI 1 according to the list 3 and which is MBS supporting according to list 2b, followed by
the target frequency which supports FSAI 1 of TMGI 1 according to the list 3 and which is not MBS supporting according to list 2b, followed by
Other target frequencies.

### Example Solution 3a (a Connection Solution Reusing FSAI, FSAIs Allocated Only to Shared Delivery Not to Individual Delivery)

In this solution, the terminal device 110 may have a service announcement comprising mapping between TMGI(s) and FSAI(s). The terminal device 110 may receive the MBS configuration from the serving gNB1 cell 1. In this solution, the serving gNB1cell 1 may broadcast the list 3 of mapping (neighbour frequencies, FSAI (s)). The serving gNB1 cell 1 may additionally broadcast the list 3b indicating the mapping between FSAI(s) and neighbour cells. Alternatively, the serving gNB1 cell 1 may broadcast the list 3c indicating the mapping between neighbour frequencies and neighbour cells. Alternatively, the terminal device 110 may deduce the list 3c from its own (neighbour cells, neighbour frequencies) mapping, if the serving gNB1 cell 1 broadcasts neither list 3b nor the list 3c.

In this solution, the terminal device 110 is configured with or indicated the FSAI(s) allocated only to the shared delivery, which means no FSAI(s) allocated to the individual delivery. Therefore, the FSAIs in the MBS configuration may comprise FSAIs only associated with an MBS shared delivery mode or alternatively only associated with an MBS individual delivery mode.

Before the cell reselection algorithm is triggered, the terminal device 110 may check it is heading towards a target cell which does not support FSAI 1 of TMGI 1 (e.g. by use of the service announcement) in shared delivery according to list 3b (or alternatively according to list 3 and 3c) but is still within the service area. That is, the terminal device 110 checks whether the target cell is a cell of type 2 (i.e. supporting TMGI but still within the service area and therefore assumed to be non-MBS supporting). If yes, the terminal device 110 may trigger RRC reconnection in the current serving gNB 1 cell 1 to reach RRC connected mode.

### Example Solution 3b (Reselection Solution Reusing FSAI, FSAI Allocated Only to Shared Delivery Not to Individual Delivery)

In this solution, the terminal device 110 may have a service announcement comprising mapping between TMGI(s) and FSAI(s). The terminal device 110 may receive the MBS configuration from the serving gNB1 cell 1. In this embodiment, the serving gNB1 cell 1 may broadcast the list 3 of mapping (neighbour frequencies, FSAI (s)). The serving gNB1 cell 1 may additionally broadcast the list 3c indicating the mapping between neighbour frequencies and neighbour cells. Alternatively, the terminal device 110 may deduce the list 3c from its own (neighbour cell, neighbour frequency) mapping if not broadcasted by the serving gNB1 cell 1.

In this embodiment, the terminal device 110 is configured with or indicated FSAI(s) allocated only to the shared delivery too. Therefore, the FSAIs in the MBS configuration may comprise FSAIs only associated with an MBS shared delivery mode. Alternatively the FSAIs in the MBS configuration may comprise FSAIs only associated with an MBS individual delivery mode.

The reselection algorithm of terminal device 110 may take into account the list 3 and the list 3c. The terminal device 110 may prioritize neighbour frequencies, for example, as below:
the target frequency which supports FSAI 1 of TMGI 1 according to the list 3, followed by
the target frequency which supports FSAI 1 of TMGI 1 in shared delivery according to list 3 but which corresponds to a target cell within the multicast area of TMGI 1 according to list 3c, followed by
Other target frequencies.

FIG. 3 illustrates an example flowchart of a method 300 implemented at a network device according to example embodiments of the present disclosure. For the purpose of discussion, the method 300 will be described from the perspective of the network device 120 with reference to FIG. 1 and FIG. 2.

As shown in FIG. 3, at block 310, the network device 120 may transmit, to a terminal device 110, a multicast/broadcast service, MBS, configuration of one or more neighbour cells or neighbour frequencies for the terminal device in an inactive state. The MBS configuration is indicative of information on at least one type of MBS transmission for one or more MBS services applicable in the one or more neighbour cells or neighbour frequencies or a cell type of the one or more neighbour cells in terms of supporting or not supporting MBS.

In some example embodiments, the at least one type of MBS transmission may include any of the following: an MBS shared delivery mode; an MBS individual delivery mode; or an MBS non-delivery mode.

In some example embodiments, the MBS configuration may comprise a list of the one or more neighbour cells or frequencies and indication information corresponding to the one or more neighbour cells or frequencies. The indication information may be indicative of the at least one type of MBS transmission for the one or more MBS services respectively in the one or more neighbour cells for the one or more MBS services. Additionally or alternatively, the indication information may be indicative of a cell type of the one or more neighbour cells in terms of supporting or not supporting MBS or not supporting MBS. For example, cells not supporting MBS are due to the fact they belong to gNBs not supporting MBS.

In some example embodiments, the MBS configuration may further comprise any of the following: a list of neighbour cells supporting MBS; a list of neighbour cells offering the one or more MBS services in an MBS shared delivery mode; a list of neighbour cells not supporting MBS; or a list of neighbour cells offering the one or more MBS services in an MBS individual delivery mode.

In some example embodiments, the MBS configuration may further comprise one or more of the following:
a list of neighbour frequencies supporting MBS;
a list of neighbour frequencies not supporting MBS;
a list of neighbour frequencies offering the one or more MBS services in an MBS shared delivery mode; or
a list of neighbour frequencies offering the one or more MBS services in an MBS individual delivery mode.

In some example embodiments, the MBS configuration may comprise any of the following: a list of the one or more neighbour cells and one or more TMGIs respectively supported in the one or more neighbour cells; or a list of one or more neighbour frequencies and one or more TMGIs respectively supported on the one or more neighbour frequencies.

In some example embodiments, the MBS configuration may further comprise a list of one or more neighbour frequencies and one or more FSAIs respectively supported on the one or more neighbour frequencies.

In some example embodiments, the MBS configuration may further comprise one or more of the following: a list of one or more neighbour FSAIs and at least one neighbour cell respectively supporting one or more neighbour FSAIs; or a list of one or more neighbour frequencies and at least one neighbour cell respectively supported on one or more neighbour frequencies.

In some example embodiments, the FSAIs in the MBS configuration may comprise both FSAIs associated with the MBS shared delivery mode and FSAIs associated with the MBS individual delivery mode. Alternatively, in some example embodiments, the FSAIs in the MBS configuration may comprise FSAIs only associated with an MBS shared delivery mode. Alternatively the FSAIs in the MBS configuration may comprise FSAIs only associated with an MBS individual delivery mode.

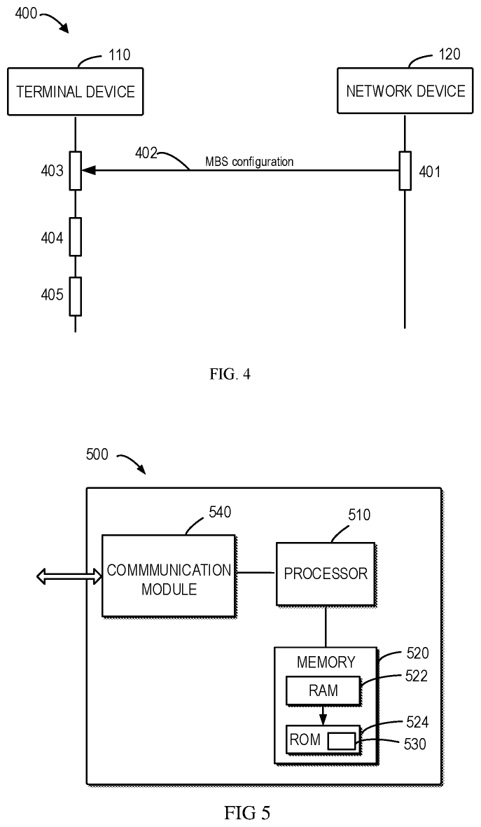

FIG. 4 illustrates an example signaling process for reporting measurements on reference signals according to some embodiments of the present disclosure. For the purpose of discussion, the process 400 will be described with reference to FIG. 1 to FIG. 3. The process 400 may involve the terminal device 110 and network devices 120 as illustrated in FIG. 1. It would be appreciated that although the process 400 has been described in the communication environment 100 of FIG. 1, this process may be likewise applied to other communication scenarios with similar issues.

The network device 120 may provide a serving cell to the terminal device 110. In the process 600, at 401, the network device 120 transmits, to the terminal device 110, an MBS configuration of one or more neighbour cells or neighbour frequencies for the terminal device in an inactive state. At 403, the terminal device 110 receives the MBS configuration 402 from the network device 120. The MBS configuration 402 is indicative of information on at least one type of MBS transmission for one or more MBS services applicable in the one or more neighbour cells or neighbour frequencies or a cell type of the one or more neighbour cells in terms of supporting or not supporting MBS.

In some example embodiments, the MBS configuration may comprise a list of the one or more neighbour cells or frequencies and indication information corresponding to the one or more neighbour cells or frequencies. The indication information may be indicative of the at least one type of MBS transmission respectively supported in the one or more neighbour cells for the one or more MBS services. Additionally or alternatively, the indication information may be indicative of a cell type of the one or more neighbour cells in terms of supporting MBS or not supporting MBS.

In some example embodiments, the MBS configuration may further comprise any of the following:
a list of neighbour cells supporting MBS;
a list of neighbour cells offering the one or more MBS services in an MBS shared delivery mode;
a list of neighbour cells not supporting MBS; or
a list of neighbour cells offering the one or more MBS services in an MBS individual delivery mode.

In some example embodiments, the MBS configuration may further comprise any of the following: a list of neighbour frequencies supporting MBS; a list of neighbour frequencies not supporting MBS; a list of neighbour frequencies offering the one or more MBS services in an MBS shared delivery mode; or a list of neighbour frequencies offering the one or more MBS services in an MBS individual delivery mode.

In some example embodiments, the MBS configuration may comprise any of the following:
a list of the one or more neighbour cells and one or more TMGIs respectively supported in the one or more neighbour cells; or
a list of one or more neighbour frequencies and one or more TMGIs respectively supported on the one or more neighbour frequencies.

In some example embodiments, the MBS configuration may further comprise a list of one or more neighbour frequencies and one or more FSAIs respectively supported on the one or more neighbour frequencies.

In some example embodiments, the MBS configuration may further comprise one or more of the following: a list of one or more neighbour FSAIs and at least one neighbour cell respectively supporting one or more neighbour FSAIs; or a list of one or more neighbour frequencies and at least one neighbour cell respectively supported on one or more neighbour frequencies.

In some example embodiments, the FSAIs in the MBS configuration may comprise both FSAIs associated with the MBS shared delivery mode and FSAIs associated with the MBS individual delivery mode. Alternatively, in some example embodiments, the FSAIs in the MBS configuration may comprise FSAIs only associated with an MBS shared delivery mode. Alternatively the FSAIs in the MBS configuration may comprise FSAIs only associated with an MBS individual delivery mode

At 404, the terminal device 110 identifies, using the received MBS configuration, at least one type of MBS transmission for one or more MBS services applicable in the one or more neighbour cells or neighbour frequencies. In some embodiments, the at least one type of MBS transmission may include any of the following: an MBS shared delivery mode; an MBS individual delivery mode; or an MBS non-delivery mode. In some embodiments, the at least one type of MBS transmission is determined based on knowledge of MBS service areas.

At 405, the terminal device 110 performs a mobility related operation based on at least one type of MBS transmission. In some embodiments, performing the mobility related operation may comprise determining, based on the identified at least one type of MBS transmission, that the terminal device is heading towards a target cell providing an MBS service in an individual delivery mode; and performing an RRC reconnection in the serving cell before a cell reselection.

Additional or alternatively, performing the mobility related operation may comprise performing a cell reselection based on frequency priorities of the one or more neighbour cells. The frequency priorities of the one or more neighbour cells may be determined based on the at least one type of MBS transmission for the one or more MBS services applicable in the one or more neighbour cells.

In some embodiments, determining frequency priorities of the one or more neighbour cells may comprise obtaining a prioritized list of neighbour frequencies of the one or more neighbour cells based on the identified at least one type of MBS transmission for the one or more MBS services in the one or more neighbour cells. The neighbour frequencies may be prioritized in an order of supporting an MBS shared delivery mode, supporting an MBS individual delivery mode, and not supporting a delivery of the one or more MBS services.

In some embodiments, an apparatus of a terminal device capable of performing the method 200 is provided. The apparatus may comprise means for performing the respective steps of the method 300. The means may be implemented in any suitable form. For example, the means may be implemented in a circuitry or software module.

The apparatus of the terminal device may comprise means for receiving, from a serving cell, a multicast/broadcast service, MBS, configuration of one or more neighbour cells or neighbour frequencies for the terminal device in an inactive state; means for identifying, using the received MBS configuration, at least one type of MBS transmission for one or more MBS services applicable in the one or more neighbour cells or frequencies; and means for performing a mobility related operation based on the at least one type of MBS transmission.

In some example embodiments, the at least one type of MBS transmission may include any of the following: an MBS shared delivery mode; an MBS individual delivery mode; or an MBS non-delivery mode.

In some example embodiments, the means for performing a mobility related operation based on the MBS configuration may comprise means for determining, based on the identified at least one type of MBS transmission, that the terminal device is heading towards a target cell providing an MBS service in an individual delivery mode; and means for performing a radio resource control, RRC, reconnection in the serving cell before a cell reselection.

In some example embodiments, the means for performing a mobility related operation based on the at least one type of MBS transmission may comprise means for performing a cell reselection based on frequency priorities of the one or more neighbour cells. The frequency priorities of the one or more neighbour cells may be determined based on the identified at least one type of MBS transmission for the one or more MBS services applicable in the one or more neighbour cells.

In some example embodiments, the means for performing a mobility related operation based on the at least one type of MBS transmission may comprise means for obtaining a prioritized list of neighbour frequencies of the one or more neighbour cells based on the identified at least one type of MBS transmission for the one or more MBS services in the one or more neighbour cells. The neighbour frequencies may be prioritized in an order of supporting an MBS shared delivery mode, supporting an MBS individual delivery mode, and not supporting a delivery of the one or more MBS services.

In some example embodiments, the MBS configuration may comprise a list of the one or more neighbour cells or frequencies and indication information corresponding to the one or more neighbour cells or frequencies. The indication information may be indicative of the at least one type of MBS transmission respectively supported in the one or more neighbour cells for the one or more MBS services. Additionally or alternatively, the indication information may be indicative of a cell type of the one or more neighbour cells in terms of supporting MBS or not supporting MBS.

In some example embodiments, the MBS configuration may further comprise any of the following: a list of neighbour cells supporting MBS; a list of neighbour cells offering the one or more MBS services in an MBS shared delivery mode; a list of neighbour cells not supporting MBS; or a list of neighbour cells offering the one or more MBS services in an MBS individual delivery mode.

In some example embodiments, the MBS configuration may further comprise any of the following: a list of neighbour frequencies supporting MBS; a list of neighbour frequencies not supporting MBS; a list of neighbour frequencies offering the one or more MBS services in an MBS shared delivery mode; or a list of neighbour frequencies offering the one or more MBS services in an MBS individual delivery mode.

In some example embodiments, the MBS configuration may comprise any of the following: a list of the one or more neighbour cells and one or more TMGIs respectively supported in the one or more neighbour cells; or a list of one or more neighbour frequencies and one or more TMGIs respectively supported on the one or more neighbour frequencies.

In some example embodiments, the MBS configuration may further comprise a list of one or more neighbour frequencies and one or more FSAIs respectively supported on the one or more neighbour frequencies.

In some example embodiments, the MBS configuration may further comprise one or more of the following: a list of one or more neighbour FSAIs and at least one neighbour cell respectively supporting one or more neighbour FSAIs; or a list of one or more neighbour frequencies and at least one neighbour cell respectively supported on one or more neighbour frequencies.

In some example embodiments, the FSAIs in the MBS configuration may comprise both FSAIs associated with the MBS shared delivery mode and FSAIs associated with the MBS individual delivery mode. Alternatively, in some example embodiments, the FSAIs in the MBS configuration may comprise FSAIs only associated with an MBS shared delivery mode. Alternatively, the FSAIs in the MBS configuration may comprise FSAIs only associated with an MBS individual delivery mode.

In some example embodiments, the at least one type of MBS transmission for an MBS service may be determined based on knowledge of MBS service area of that MBS service.

In some embodiments, an apparatus of a network device capable of performing the method 300 may comprise means for performing the respective steps of the method 300. The means may be implemented in any suitable form. For example, the means may be implemented in a circuitry or software module.

The apparatus of the network device is further provided. The apparatus may comprise means for transmitting, to a terminal device, a multicast/broadcast service. MBS, configuration of one or more neighbour cells or neighbour frequencies for the terminal device in an inactive state, wherein the MBS configuration is indicative of information on at least one type of MBS transmission for one or more MBS services applicable in the one or more neighbour cells or neighbour frequencies or a cell type of the one or more neighbour cells in terms of supporting or not supporting MBS.

In some example embodiments, the at least one type of MBS transmission may include any of the following: an MBS shared delivery mode; an MBS individual delivery mode; or an MBS non-delivery mode.

In some example embodiments, the MBS configuration may comprise a list of the one or more neighbour cells or frequencies and indication information corresponding to the one or more neighbour cells or frequencies. The indication information may be indicative of the at least one type of MBS transmission respectively supported in the one or more neighbour cells for the one or more MBS services. Additionally or alternatively, the indication information may be indicative of a cell type of the one or more neighbour cells in terms of supporting MBS or not supporting MBS.

In some example embodiments, the MBS configuration may further comprise any of the following: a list of neighbour cells supporting MBS; a list of neighbour cells offering the one or more MBS services in an MBS shared delivery mode; a list of neighbour cells not supporting MBS; or a list of neighbour cells offering the one or more MBS services in an MBS individual delivery mode.

In some example embodiments, the MBS configuration may further comprise any of the following: a list of neighbour frequencies supporting MBS; a list of neighbour frequencies not supporting MBS; a list of neighbour frequencies offering the one or more MBS services in an MBS shared delivery mode; or a list of neighbour frequencies offering the one or more MBS services in an MBS individual delivery mode.

In some example embodiments, the MBS configuration may comprise any of the following: a list of the one or more neighbour cells and one or more TMGIs respectively supported in the one or more neighbour cells; or a list of one or more neighbour frequencies and one or more TMGIs respectively supported on the one or more neighbour frequencies.

In some example embodiments, the MBS configuration may further comprise a list of one or more neighbour frequencies and one or more FSAIs respectively supported on the one or more neighbour frequencies.

In some example embodiments, the MBS configuration may further comprise one or more of the following: a list of one or more neighbour FSAIs and at least one neighbour cell respectively supporting one or more neighbour FSAIs; or a list of one or more neighbour frequencies and at least one neighbour cell respectively supported on one or more neighbour frequencies.

In some example embodiments, the FSAIs in the MBS configuration may comprise both FSAIs associated with the MBS shared delivery mode and FSAIs associated with the MBS individual delivery mode. Alternatively, in some example embodiments, the FSAIs in the MBS configuration may comprise FSAIs only associated with an MBS shared delivery mode. Alternatively, the FSAIs in the MBS configuration may comprise FSAIs only associated with an MBS individual delivery mode.

The proposed solutions may achieve various advantages over related arts in that a terminal device in the inactive state while receiving in a serving cell an ongoing multicast service can discriminate different types of potential target cells for its mobility, and perform mobility related operations based on the identified types to improve the MBS multicast services. For example, during movement to a target cell identified as not supporting MBS, the terminal device may reestablish a RRC connected state in the serving cell, such that it can reduce the interrupt and data loss caused by the switch from the shared delivery mode to the individual mode. In addition, the terminal device may also take into account the frequencies of the identified types of potential target cells for the availability of MBS service when it is making a cell reselect decision, so as to ensure continuity of its MBS service.

FIG. 5 is a simplified block diagram of a device 500 that is suitable for implementing embodiments of the present disclosure. The device 500 may be provided to implement the communication device, for example the terminal device 110 or the network device 120 as shown in FIG. 1. As shown, the device 500 includes one or more processors 510, one or more memories 520 may be coupled to the processor 510, and one or more transmitters and/or receivers (TX/RX) 540 may be coupled to the processor 510.

The TX/RX 540 is for bidirectional communications. The TX/RX 540 has at least one antenna to facilitate communication. The communication interface may represent any interface that is necessary for communication with other network elements. The communication interface may be hardware or software based interface. For example, the communication interface may be one or more transceivers. The one or more transceivers may be coupled to one or more antennas or antenna ports to wirelessly transmit and/or receive communication signals. The antennas or antenna ports may be the same or different types. The antennas or antenna ports may be located in different positions of an apparatus. The one or more transceivers allow the apparatus to communicate with other devices that may be wired and/or wireless. The transceiver may support one or more radio technologies. For example, the one or more transceivers may include a cellular subsystem, a WLAN subsystem, and/or a Bluetooth™ subsystem. The one or more transceivers may include processors, controllers, radios, sockets, plugs, buffers, or the like circuits to form one or more communication channels to one or more radio frequency units.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a read only memory (ROM) 524, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The program 530 may be stored in the ROM 524. The processor 510 may perform any suitable actions and processing by loading the program 530 into the RAM 522.

The embodiments of the present disclosure may be implemented by means of the program so that the device 500 may perform any process of the disclosure as discussed with reference to FIG. 2 to FIG. 4. The embodiments of the present disclosure may also be implemented by hardware or by a combination of software and hardware.

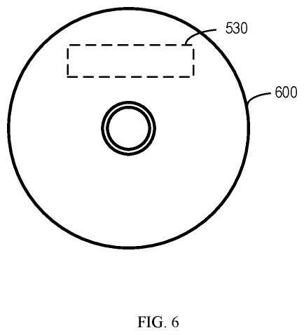

In some embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. The computer readable medium may include any types of tangible non-volatile storage, such as ROM, EPROM, a flash memory, a hard disk, CD, DVD, and the like. FIG. 6 shows an example of the computer readable medium 600 in form of CD or DVD. The computer readable medium has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 300, 400, or process 500 as described above with reference to FIG. 3, FIG. 4 and FIG. 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-47. (canceled)

48. A terminal device, comprising:
at least one processor; and
at least one memory including computer program codes, wherein the at least one memory and the computer program codes are configured to, with the at least one processor, cause the terminal device to:
receive, from a serving cell, a multicast/broadcast service, MBS, configuration of one or more neighbour cells or neighbour frequencies for the terminal device in an inactive state,
identify, using the received MBS configuration, at least one type of MBS transmission for one or more MBS services applicable in the one or more neighbour cells or neighbour frequencies; and
perform a mobility related operation based on the at least one type of MBS transmission.

49. The terminal device of claim 48, wherein the at least one type of MBS transmission includes any of:
an MBS shared delivery mode;
an MBS individual delivery mode; or
an MBS non-delivery mode.

50. The terminal device of claim 48, wherein the performing the mobility related operation comprises the at least one memory and the computer program codes are configured to, with the at least one processor, cause the terminal device to:
determine, based on the identified at least one type of MBS transmission, that the terminal device is heading towards a target cell providing an MBS service in an individual delivery mode; and
perform a radio resource control, RRC, reconnection in the serving cell before a cell reselection.

51. The terminal device of claim 48, wherein the performing the mobility related operation comprises the at least one memory and the computer program codes are configured to, with the at least one processor, cause the terminal device to:
perform a cell reselection based on frequency priorities of the one or more neighbour cells,
wherein the frequency priorities of the one or more neighbour cells are determined based on the identified at least one type of MBS transmission for the one or more MBS services applicable in the one or more neighbour cells.

52. The terminal device of claim 51, wherein the frequency priorities of the one or more neighbour cells are determined by:
obtaining a prioritized list of neighbour frequencies of the one or more neighbour cells based on the identified at least one type of MBS transmission for the one or more MBS services in the one or more neighbour cells,
wherein the neighbour frequencies are prioritized in an order of supporting an MBS shared delivery mode, supporting an MBS individual delivery mode, and not supporting a delivery of the one or more MBS services.

53. The terminal device of claim 48, wherein the MBS configuration comprises:
a list of the one or more neighbour cells or frequencies and indication information corresponding to the one or more neighbour cells or frequencies,
wherein the indication information is indicative of at least one of the following:
the at least one type of MBS transmission respectively supported in the one or more neighbour cells for the one or more MBS services; or
a cell type of the one or more neighbour cells in terms of supporting or not supporting MBS.

54. The terminal device of claim 48, wherein the MBS configuration further comprises any of:
a list of neighbour cells supporting MBS; or
a list of neighbour cells offering the one or more MBS services in an MBS shared delivery mode; or
a list of neighbour cells not supporting MBS; or
a list of neighbour cells offering the one or more MBS services in an MBS individual delivery mode.

55. The terminal device of claim 48, wherein the MBS configuration further comprises any of:
a list of neighbour frequencies supporting MBS;
a list of neighbour frequencies not supporting MBS;
a list of neighbour frequencies offering the one or more MBS services in an MBS shared delivery mode; or
a list of neighbour frequencies offering the one or more MBS services in an MBS individual delivery mode.

56. The terminal device of claim 54, wherein the MBS configuration comprises any of:
a list of the one or more neighbour cells and one or more temporary mobile group identities, TMGIs, respectively supported in the one or more neighbour cells; or
a list of one or more neighbour frequencies and one or more TMGIs respectively supported in one or more neighbour frequencies.

57. The terminal device of claim 48, wherein the MBS configuration further comprises:
a list of one or more neighbour frequencies and one or more frequency selection area identities, FSAIs, respectively supported on the one or more neighbour frequencies.

58. The terminal device of claim 57, wherein the MBS configuration further comprises one or more of:
a list of one or more neighbour FSAIs and at least one neighbour cell respectively supporting one or more neighbour FSAIs; or
a list of one or more neighbour frequencies and at least one neighbour cell respectively supported on one or more neighbour frequencies.

59. The terminal device of claim 58, wherein the list of one or more neighbour frequencies and at least one neighbour cell respectively supported on one or more neighbour frequencies is determined from information on neighbour cells and corresponding neighbour frequencies.

60. The terminal device of claim 57, wherein the FSAIs in the MBS configuration comprise both FSAIs associated with the MBS shared delivery mode and FSAIs associated with the MBS individual delivery mode.

61. The terminal device of claim 57, wherein the FSAIs in the MBS configuration comprise FSAIs only associated with one of an MBS shared delivery mode or an MBS individual delivery mode.

62. The terminal device of claim 48, wherein the at least one type of MBS transmission for an MBS service is determined based on knowledge of MBS service area of that MBS service.

63. A network device, comprising:
at least one processor; and
at least one memory including computer program codes, wherein the at least one memory and the computer program codes are configured to, with the at least one processor, cause the network device providing a serving cell to:
transmit, to a terminal device, a multicast/broadcast service, MBS, configuration of one or more neighbour cells or frequencies for the terminal device in an inactive state,
wherein the MBS configuration is indicative of information on one of:
at least one type of MBS transmission for one or more MBS services applicable in the one or more neighbour cells or neighbour frequencies; or
a cell type of the one or more neighbour cells in terms of supporting or not supporting MBS.

64. The network device of claim 63, wherein the at least one type of MBS transmission includes any of:
an MBS shared delivery mode;
an MBS individual delivery mode; or
an MBS non-delivery mode.

65. The network device of claim 63, wherein the MBS configuration comprises:
a list of the one or more neighbour cells or frequencies and indication information corresponding to the one or more neighbour cells or neighbour frequencies,
wherein the indication information is indicative of at least one of the following:
the at least one type of MBS transmission respectively supported in the one or more neighbour cells for the one or more MBS services; or
a cell type of the one or more neighbour cells in terms of supporting or not supporting MBS.

66. The network device of claim 63, wherein the MBS configuration further comprises any of:
a list of neighbour cells supporting MBS; or
a list of neighbour cells offering the one or more MBS services in an MBS shared delivery mode; or
a list of neighbour cells not supporting MBS; or
a list of neighbour cells offering the one or more MBS services in an MBS individual delivery mode.

67. A method at a terminal device comprising:
receiving, from a serving cell, a multicast/broadcast service, MBS, configuration of one or more neighbour cells or neighbour frequencies for the terminal device in an inactive state,
identifying, using the received MBS configuration, at least one type of MBS transmission for one or more MBS services applicable in the one or more neighbour cells or neighbour frequencies; and
performing a mobility related operation based on the at least one type of MBS transmission.
